(19) United States
(12) Patent Application Publication
(10) Pub. No.: US 2004/0008278 A1
(43) Pub. Date: Jan. 15, 2004

(54) System and method for obscuring a portion of a displayed image

(76) Inventor: Jerry Iggulden, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/192,929

(22) Filed: Jul. 9, 2002

(51) Int. Cl. H04N 5/44

(52) U.S. Cl. 348/553

(57) ABSTRACT

System and method for obscuring a portion of a displayed image. A method includes displaying a menu which allows a viewer to specify screen blocking criteria. The screen blocking criteria are received, and a portion of a viewable screen image that typically includes crawling text is obscured or blocked from view based on the screen blocking criteria. The method may be implemented in a television, set top box or similar device.

### FIELD OF THE INVENTION

This invention relates to television, and more specifically to selectively blocking a portion of a television image in response to a user's selection of a screen region to be obscured.

### BACKGROUND OF THE INVENTION

Televisions are ubiquitous in American culture. Televisions have their place in American homes, as well as in recreational locales such as bars, restaurants and the like. With the popularity of cable television and the ever increasing screen sizes made available to television viewers by television manufacturers, various cable television and other stations have been providing additional features on a traditional television display. For example, some television news stations include crawling text on the bottom of their television images. That is, along with a news broadcaster and associated graphics or other information, a scrolling text portion of a screen may provide news items unrelated to what is currently being broadcast in an effort to enhance the amount of information provided to the viewer. In this way, a viewer may multi-process two screens of information. This technique is also used for sports television stations which may have scores crawling across the bottom of the screen and by financial news stations which may have a ticker showing stocks and their current prices and other related information on the bottom of a screen. Sometimes, two or more scrolling text portions may be provided to display, for example, sports scores and sporting news, business news and stock ticker, and various other combinations. Further, commercials and promotions for upcoming programs and for products may be provided in this region of the screen, in text and/or graphic form.

The scrolling text and crawling text, ticker, sports scores and the like are often referred to as “crawl.” Crawl may be any textual and/or graphic information that moves horizontally from the right of a screen to the left of a screen on which a television program is concurrently being broadcast. Crawl may also occur from right to left. Crawl is typically included on a bottom portion of a television screen or broadcast, and may also be provided at the top of a television screen or broadcast. Multiple crawl regions may be stacked at the bottom of a television broadcast. Crawl may also be scrolled vertically within a portion of the bottom of a screen or at the top of a screen. This vertical crawl may be like closed-captioning that accompanies many television broadcasts in that the content of the crawl may appear as if it is being typed onto the screen one letter or one word at a time in which the text scrolls up a line when an end of a bottom or top line is reached. It is also possible that crawl may be provided in a region along the left or right side of a broadcast such that the crawl moves vertically from bottom to top or top to bottom.

Although the added information in a crawling text region of a screen provided by the television broadcaster is intended to enhance the viewing experience of television watchers, many people find the additional information contained in the moving text annoying and distracting from the main program which the viewer would rather watch. Television broadcasters do not provide television viewers the option to blank out or remove the crawling text portion of their broadcast.

### SUMMARY OF THE INVENTION

System and method for obscuring a portion of a displayed image. A method includes displaying a menu which allows a viewer to specify screen blocking criteria. The screen blocking criteria are received, and a portion of a viewable screen image that typically includes crawling text is obscured or blocked from view based on the screen blocking criteria. The method may be implemented in a television, set top box or similar device.

### BRIEF DESCRIPTION OF THE DRAWINGS

FIG. 1A illustrates an example television broadcast having text crawl in a region of the screen.

FIG. 1B illustrates an example television broadcast with the text crawl region obscured according to an embodiment described herein.

FIGS. 2A and 2B illustrate user interface menus which may be provided to a television viewer according to the systems and methods described herein.

FIG. 3 illustrates an example television broadcast image with a defining region shown thereon.

FIG. 4 illustrates a flow of actions taken according to an embodiment of the selective blocking system described herein.

FIG. 5 illustrates a television configured according to the methods described herein.

### DETAILED DESCRIPTION

The system and methods described herein allow a television viewer to regain control of their television set. More specifically, the systems and methods describe herein allow a television viewer to selectively obscure a region of a television broadcast.

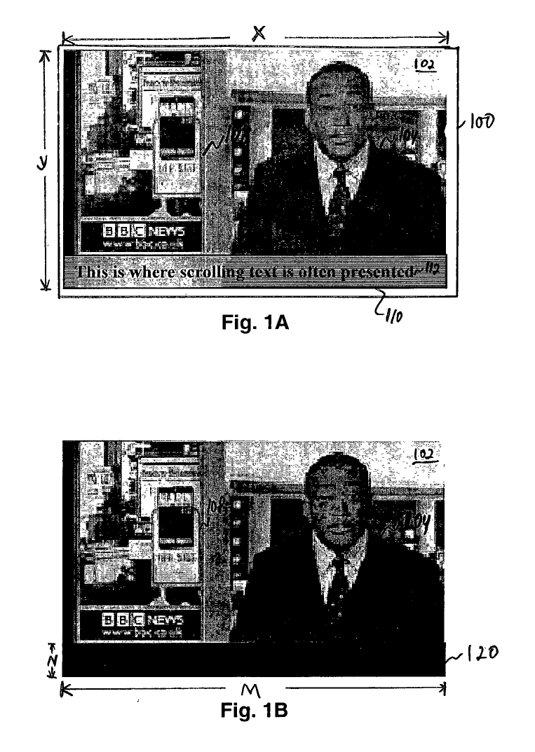

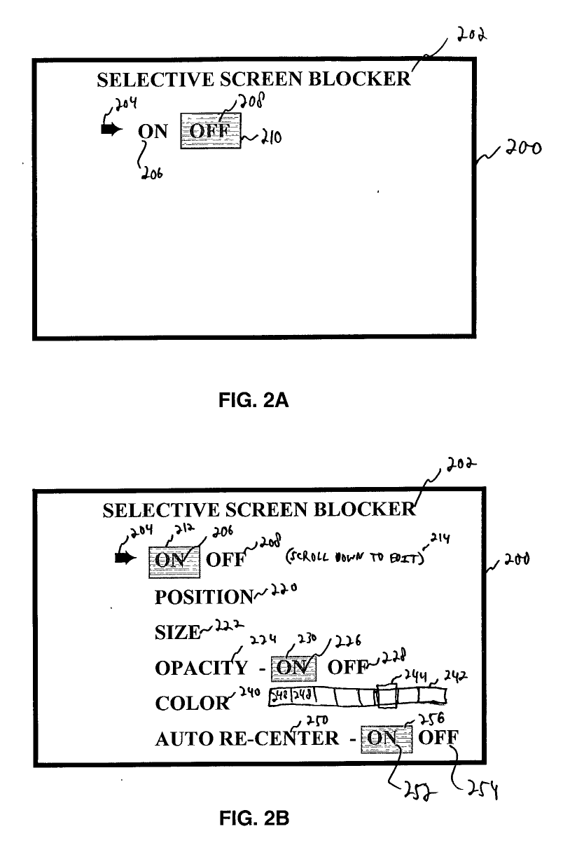

FIG. 1A illustrates an example television broadcast having text crawl in a region of the screen. Those television broadcasters who provide crawling text to television viewers typically do so at a bottom portion of the television screen. In the television news context, television 100 displaying broadcast image 102 typically contains a news anchor 104. When the news anchor reads the news and otherwise reports, additional information regarding the story is typically presented in a graphic or other display over the shoulder of the anchor, such as shown in graphic 108. To provide the viewer with additional news information while the viewer is listening to and watching the anchor broadcast the news, a bottom region of the screen 110 may include horizontally moving or crawling text 112 which describes news stories in addition to and typically unrelated to the news story being broadcast by the anchor. Some television viewers find the added text crawl provided by television broadcasters annoying and distracting.

FIG. 1B illustrates an example television broadcast with the text crawl region obscured according to an embodiment described herein. The systems and methods described herein allow a user to specify blocking region 120 which obscures the text crawl region provided on television broadcast image 102. The television broadcast image may have dimensions width X and height Y. In one embodiment, a user may select a blocking region which is a user defined height N having a width M which is the same width as the television broadcast region. That is, M=X. In one embodiment, the width M of the blocking region may be smaller than the width X of the television broadcast image. In one embodiment, the television viewer selects the size and position of the blocking region. In another embodiment, the blocking region may be provided according to auto-sensing or auto-detecting techniques.

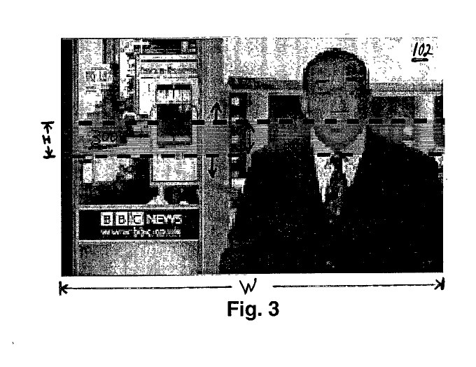

FIGS. 2A and 2B illustrate user interface menus which may be provided to a television viewer according to the systems and methods described herein. In one embodiment, when a user presses a particular button on or otherwise activates a remote control associated with a television set or set top box, the user may be provided a selective screen blocker menu 200. In another embodiment, when a television viewer is editing customizable features of a television (i.e., set-up options), the selective screen blocker may be provided as an additional editable option. A selective screen blocker menu 200 may include in a first line an “On-Off” designator which shows whether selective screen blocking is set to “On” 206 or “Off” 208. To show whether the selective screen blocker is “On” or “Off”, the “On” or “Off” designator may be highlighted, such as shown by highlighted region 210. Cursor 204 may designate which line of the selective screen blocker menu is currently active.

Referring to FIG. 2B, when the selective screen blocker is set to “On,” the selective screen blocker menu may provide additional text 214 which states “Scroll Down to Edit.” The viewer may scroll down to the remainder of the selective screen blocker menu by, for example, using buttons on a remote control, such as “up” and “down” buttons. The selective screen blocker menu may include various options. In one embodiment, the only options provided are “Position” 220 and “Size” 222. In this embodiment, the viewer may select the size of the screen blocking region and the position on the television broadcast image where the screen blocking region should be located. In one embodiment, a defining region may be displayed on a viewer's screen, and the viewer may move, shrink, or expand the defining region to specify the blocking region's size and location. In one embodiment, the screen blocking region that is selected by the viewer only applies to the currently viewed channel, and remains active so long as the television remains “On” and the channel is not changed. In other embodiments, a screen blocking system enhanced television may include a memory which allows the selective screen blocking features to be applied to various channels and to be remembered from television viewing session to television viewing session, and when switching from channel to channel.

In some embodiments, the selective screen blocking menu 200 may include other options such as “Opacity” 224, “Color” 240, and “Auto Re-center” 250. On those systems that include the Opacity option, the blocking region may be made opaque by a viewer selecting this option. In one embodiment, Opacity may either be “On” 226 or “Off” 228 such that a blocking region will have a system defined degree of opacity that allows some of the obscured text to be seen when Opacity is selected “On;” when Opacity is selected “Off,” the blocking region is a solid color that wholly blocks all of the fully obscured text. Highlighted rectangle 230 may be displayed to designate whether opacity is “On” or “Off.” In one embodiment, the color provided by the selective screen blocker may be limited to a single system defined color such as, black or dark blue. In one embodiment, Opacity may allow the viewer to specify various degrees of opacity of the blocking region from a menu such as a menu that lists a percentage of transparency that is used as the blocking region such as, 25%, 50%, 75% or 100%. In one embodiment, this may be achieved via a slide control such as that which is commonly used for selecting an amount of contrast. In those embodiments in which Color is provided in selective screen blocker menu 200, the viewer may be provided the option to select the color of the blocking region. Color may be provided as a menu of text items such as the words Red, Green, Blue, etc., or may be provided as a sliding color scale 242 by which a viewer slides a highlighted selector 244 over a screen display of aligned color rectangles 248.

In some embodiments, an Auto Re-center feature may be provided. In these embodiments, the screen blocking system may process the broadcast television image, subtract the blocking region from the television image, and then vertically center the remaining portion of the broadcast television image on the television screen. “Auto Recenter” may be set to “On” 252 or “Off” 254, and highlighted rectangle 256 may be used to designate whether “Auto Re-Center” is “On” or “Off.”

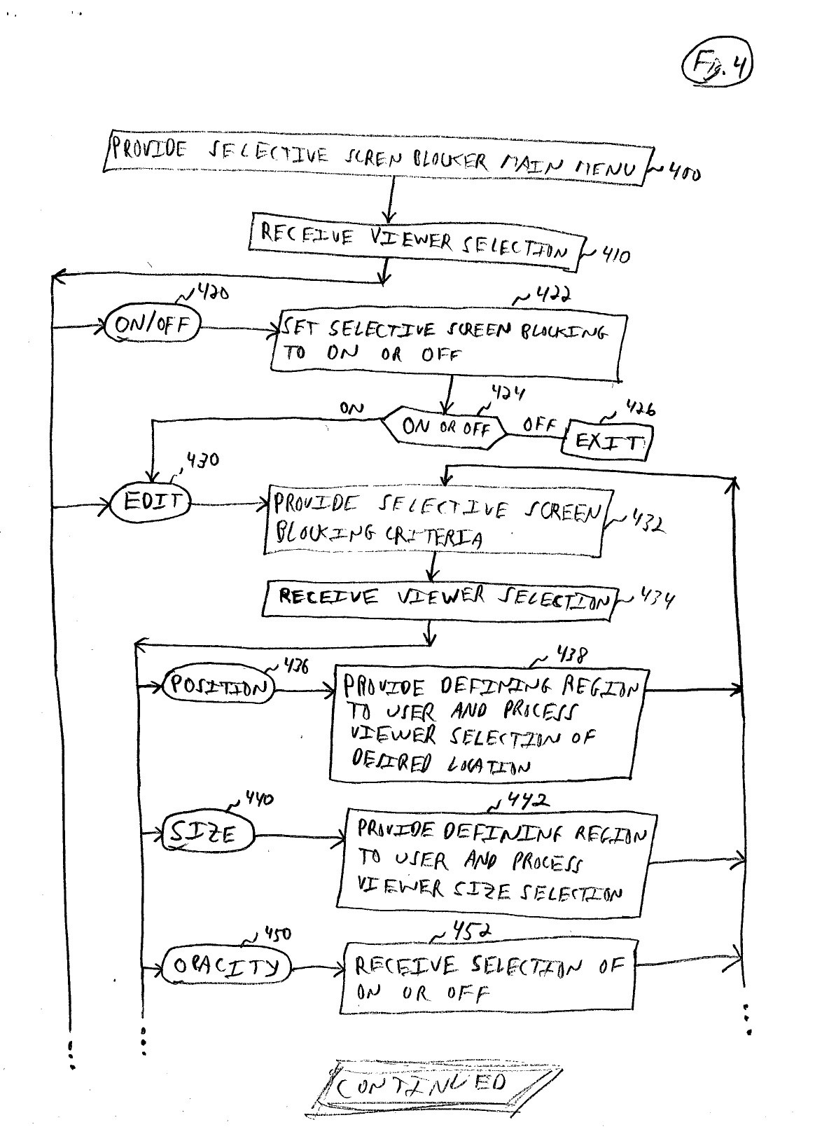

FIG. 3 illustrates an example television broadcast image with a defining region shown thereon. As discussed above regarding the selective screen blocker menu, a television viewer may be provided the ability to select the position and size of the screen blocking region. In one embodiment, when a viewer selects to activate a screen blocking region by selecting the “On” option from the selective screen blocker menu, the selective screen blocking system may present a defining region 300 on the broadcast television image 102 which allows the television viewer to select the size and position of the screen blocking region. In one embodiment, a default size screen blocking region may be provided in a system defined location. In one embodiment, the system defined location may be centered vertically on the screen. In this embodiment, the system default screen blocking region may have a width W the same width as the television broadcast image, such that W=X, referring to FIG. 1A. The default defining region may have a system defined default height H. In one embodiment, the default height H may be based on typical height of screen text crawl regions regularly provided by television broadcasters. When a television viewer is provided defining region 300, the television viewer may use various keys on a remote control device to slide the region to a desired location and to change the size of the screen blocking region. In one embodiment, only the height of the screen blocking region may be adjusted, so that the width of the screen blocking region in this embodiment is the same as the width of the television viewing area.

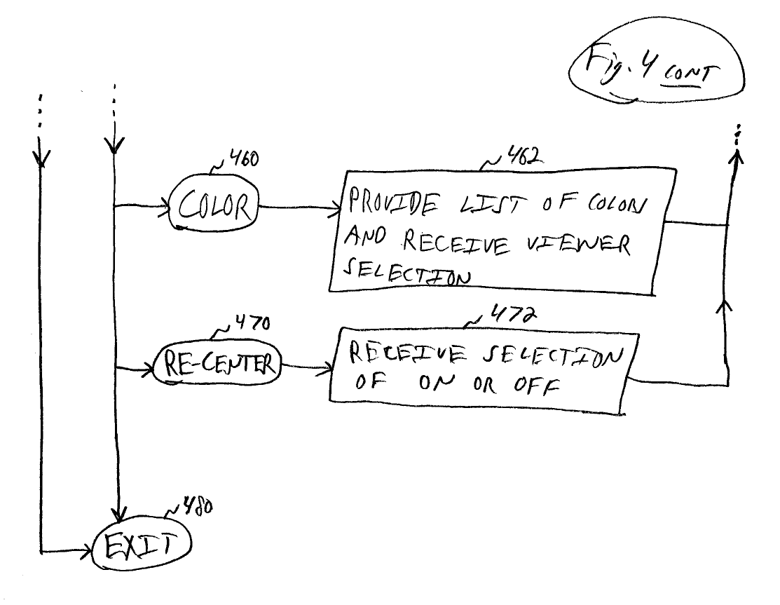

FIG. 4 illustrates a flow of actions taken according to an embodiment of the selective blocking system described herein. In one embodiment, a selective screen blocking button may be provided on a remote control. When the selective screen blocking button is activated, the selective screen blocking system may provide a selective screen blocking main menu to the viewer, as shown in block 400. An example screen blocking main menu is shown in FIG. 2A. The selective screen blocking system may receive a viewer selection, as shown in block 410. The actions of the selective screen blocking system are determined by viewer selections. If the viewer selects to set the selective screen blocking system “On” or “Off,” as shown in block 420, the selective screen blocking system sets the selective screen blocking to “On” or “Off,” as shown in block 422. If the viewer selects to activate or set “On” the screen blocking system, the viewer is allowed to edit 430 various features of the selective screen blocking region and/or other selective screen blocking system criteria. To achieve this, various screen blocking criteria are provided to the viewer, as shown in block 432. The screen blocking criteria may include position, size, opacity, color, and re-center. An example menu showing the screen blocking criteria is shown in FIG. 2B. A viewer selection of the screen blocking criteria is received and processed, as shown in block 434. In one embodiment, when the viewer selects position, as shown in block 436, a defining region is provided on the viewing area of the screen and the viewer may use remote control buttons to scroll or slide the defining region up and down the screen until a desired location is reached, as shown in block 438. When the viewer selects size, as shown in block 440, a defining region may be presented on the viewable area of the television screen which allows the viewer to change the size of the screen blocking region by scrolling buttons on a remote control, as shown in block 442. An example defining region 300 is shown in FIG. 3. In one embodiment, the horizontal size or width of the blocking region may not be altered by the viewer, such that the size and position only involve the vertical size and vertical position of the blocking region. Further, in one embodiment, only the size and position of the blocking region may be altered by the viewer.

In some embodiments, the selective screen blocking system may allow the viewer to set the opacity of the screen blocking region, as shown in block 450. In one embodiment, the screen blocking system allows the viewer to set opacity to either “On” or “Off”, as shown in block 452 such that the blocking region is solid or opaque. In other embodiments, various levels of opacity may be provided to a viewer in the screen blocking menu, so that the viewer may select via well known user interface techniques a desired opacity level. In another embodiment, the screen blocking system may provide the viewer the opportunity to edit the color of the blocking region, as shown in block 460. If the viewer selects to edit the color of the screen blocking region, the screen blocking system may provide the viewer with a menu or list of colors represented as text or color squares/swatches through which the viewer may scroll and select using a remote control, as shown in block 462. In some embodiments of the screen blocking system, the viewer may be provided the opportunity to re-center the remaining portion of the viewer's screen after a blocking region has been selected, as shown in block 470. If the viewer selects Re-center, as shown in block 470, the screen blocking system allows the viewer to select either “On” or “Off” for this option, as shown in block 472.

When editing the screen blocking feature according to the prior paragraph, the viewer may continue to edit each of the various features, or the viewer may choose to exit the screen blocking menu, as shown block 480. In addition, when initially choosing to set the screen blocking system to “On” or “Off,” if the viewer selects “Off,” as shown in blocks 422 and 424, the viewer is exits the screen blocking system, as shown in block 426. If when the viewer activates the selective screen blocking button on the remote control and the selective screen blocker is already on, in one embodiment, the selective screen blocker may automatically toggle to “Off.” In another embodiment, when the selective screen blocker is on and the appropriate remote control button is activated, the screen blocking criteria may be displayed, as shown in block 432, and the flow of actions begins at block 432.

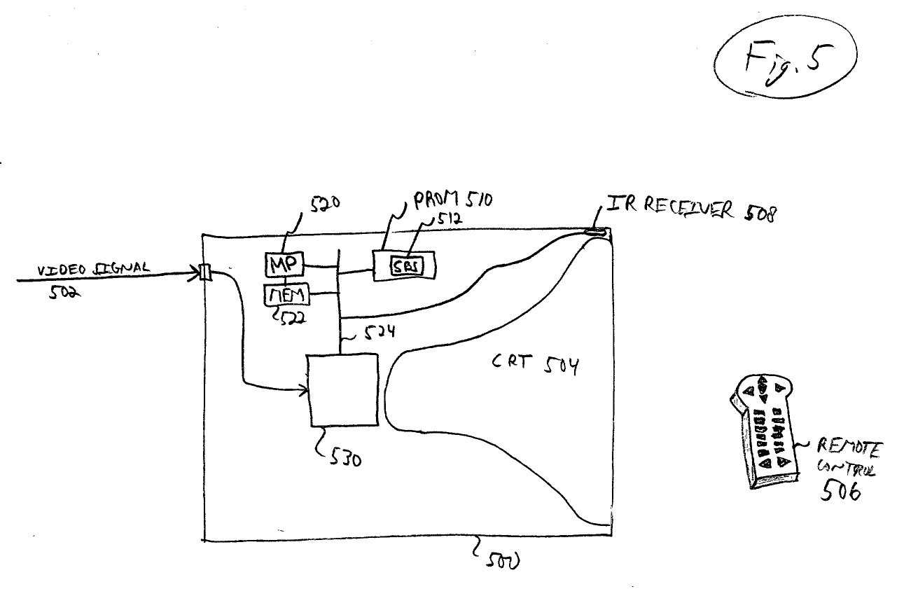

FIG. 5 illustrates a television configured according to the methods described herein. In one embodiment, television 500 receives video signal 502 and displays it to the viewer via cathode ray tube (CRT) 504. Video signal 502 may be received in any well known format such as, analogue, National Television Standards Committee (NTSC), Phase Alternating Line (PAL), composite video, high definition television (HDTV), video television (VTV), and others via cable television line, satellite broadcast, traditional television signal broadcast, the Internet, and the like. A viewer of television 500 may control channel selection and various features of the television, including the screen blocking system described herein, via remote control 506. Remote control 506 may communicate with television 500 via infrared signals according to well known techniques. Television 500 includes infrared receiver 508. To achieve the methods described, the screen blocking system may be embodied as software or a combination of hardware and software within television 500. In one embodiment, the screen blocking system 512 may exist on a programmable read only memory (PROM) 510 or other similar hardware device. In other embodiments, the screen blocking system may exist in various combination of hardware and software on one or more components within television 500. In addition, television 500 may include processor 520, memory 522, and bus 524. Via bus 524 each of processor 520, memory 522, infrared receiver 508 and PROM 510 may communicate with one another and/or share data among one another. In one embodiment, all of these components may be included in an application specific integrated circuit (ASIC). When video signal 502 arrives at television 500 well known tuner, amplifying, cleaning and other processing techniques may be applied to the signal, which may be followed by application of the selective blocking system.

In another embodiment, the methods described herein may be implemented in a similar manner in a set top box such as, a cable television receiver, satellite television receiver, personal video recorder (PVR), and the like.

In the foregoing specification, the invention has been described with reference to specific embodiments. It will, however, be evident that various modifications and changes can be made without departing from the broader spirit and scope of the invention as set forth in the appended claims. The specification and drawings are to be regarded in an illustrative rather than a restrictive sense.

What is claimed:

1. A method comprising:
displaying a screen blocking menu to a television viewer;
receiving viewer specified screen blocking criteria; and
obscuring a portion of a viewable screen image of a television broadcast based on the screen blocking criteria.

2. The method of claim 1 wherein the screen blocking criteria include at least one of a position and a size.

3. The method of claim 2 wherein the screen blocking criteria further include color and opacity.

4. The method of claim 1 wherein the screen blocking criteria include a channel specification of at least one channel.

5. The method of claim 1 further comprising:
providing a user interface to allow the viewer to specify a position and a size of a blocking region.

6. The method of claim 5 further comprising:
prompting the viewer to select whether the viewable screen image should be centered within a screen area.

7. The method of claim 1 wherein receiving comprises:
processing a viewer request to block a portion of a currently displayed screen image that includes crawling text;
automatically detecting a crawling text region in the currently displayed screen image;
computing a position and a size of a blocking region based on the crawling text region; and
setting the viewer specified screen blocking criteria based on the blocking region.

8. The method of claim 7 further comprising:
receiving viewer confirmation that the viewer specified screen blocking criteria should be based on the blocking region.

9. The method of claim 7 further comprising:
providing a user interface to allow the viewer to edit the position and the size of the blocking region.

10. The method of claim 7 further comprising:
if the blocking region is adjacent to an edge of a screen area, prompting the viewer to select whether the viewable screen image should be centered within the screen area.

11. The method of claim 1 wherein the method is implemented on a television.

12. The method of claim 1 wherein the method is implemented on a set top box.

13. A method comprising:
providing a screen blocking menu to a television viewer; and
receiving a viewer selection concerning selective screen blocking of a television broadcast;
if the viewer selection is to activate selective screen blocking,
obtaining viewer criteria regarding a blocking region of the television broadcast,
obscuring the blocking region of the television broadcast,
displaying a remainder of the television broadcast.

14. The method of claim 13 wherein the viewer criteria include at least one of a position, a size, a and an opacity of the blocking region.

15. The method of claim 13 wherein the viewer criteria include a channel specification of at least one television channel.

16. The method of claim 13 wherein the method is implemented on a television.

17. The method of claim 13 wherein the method is implemented on a set top box.

18. A method comprising:
providing a screen blocking menu to a television viewer;
receiving screen blocking criteria for at least one portion of a viewable screen image of a television broadcast for at least one channel of a plurality of television channels; and
obscuring the at least one portion of the viewable screen image based on the screen blocking criteria.

19. The method of claim 18 wherein the screen blocking criteria include at least one of a position, a size, and an opacity of the at least one portion of the viewable screen image.

20. The method of claim 18 wherein the viewer criteria include a channel specification of at least one television channel.

21. The method of claim 18 wherein the method is implemented on a television.

22. The method of claim 18 wherein the method is implemented on a set top box.

23. The method of claim 18 further comprising:
providing a user interface to allow the viewer to specify the screen blocking criteria.

24. A video device comprising:
a video display;
a user input processing unit;
a video processing unit; and
a storage device having instructions stored thereon which when executed by the video processing unit cause the video device to perform actions comprising,
displaying a screen blocking menu,
receiving user specified screen blocking criteria,
obscuring a portion of a viewable screen image based on the screen blocking criteria.

25. The video device of claim 24 wherein the screen blocking criteria include at least one of a position, a size, a color and an opacity.

26. The video device of claim 24 wherein the screen blocking criteria include a channel specification of at least one channel.

27. The video device of claim 24 having further instructions stored thereon which when executed by the video processing unit cause the video device to perform further actions comprising:
providing a user interface to allow the user to specify a position and a size of a blocking region.

28. The video device of claim 27 wherein receiving comprises:
processing a user request to block a portion of a currently displayed screen image that includes crawling text.

29. A device comprising:
means for displaying a screen blocking menu to a television viewer;
means for receiving viewer specified screen blocking criteria; and
means for obscuring a portion of a viewable screen image based on the screen blocking criteria.

30. The device of claim 29 wherein the screen blocking criteria include at least one of a position, a size, a color and an opacity.

31. The device of claim 29 further comprising:
means for providing a user interface to allow the television viewer to specify a position of a blocking region.

32. The device of claim 29 further comprising:
means for processing a viewer request to block a portion of a currently displayed television broadcast that includes crawling text.
